(19) United States
(12) Patent Application Publication
(10) Pub. No.: US 2025/0378976 A1
(43) Pub. Date: Dec. 11, 2025

(54) INSULATOR FOR AERIAL ELECTRICAL LINES WITH A MECHANICAL LOAD DETECTION DEVICE

(71) Applicant: Sediver, Courbevoie (FR)

(72) Inventors: Fabrice Mesples, Courbevoie (FR); Philippe Carteron, Courbevoie (FR); Jean-Marie George, Courbevoie (FR)

(21) Appl. No.: 18/993,164

(22) PCT Filed: Jul. 6, 2023
(86) PCT No.: PCT/EP2023/068692

§ 371 Date: Aug. 20, 2025

(30) Foreign Application Priority Data
Jul. 20, 2022 (FR) FR2207413

(51) Int. Cl. H01B 17/00; H01B 17/12

(52) U.S. Cl. CPC H01B 17/005; H01B 17/12

(57) ABSTRACT

An insulator of the cap/pin type for an aerial electrical line comprises a dielectric element that has an outer surface in the form of a skirt that is extended by a metal cap on one side and a metal pin on the other side. It also comprises a mechanical load detection device comprising at least one strain gauge fastened to the metal cap of the insulator so as to be used to detect mechanical stresses representative of a mechanical load exerted on the electrical line.

### CROSS-REFERENCE TO RELATED APPLICATIONS

This application is a national phase entry under 35 U.S.C. § 371 of International Patent Application PCT/EP2023/068692, filed Jul. 6, 2023, designating the United States of America and published as International Patent Publication WO 2024/017658 A1 on Jan. 25, 2024, which claims the benefit under Article 8 of the Patent Cooperation Treaty of French Patent Application Serial No. FR2207413, filed Jul. 20, 2022.

### TECHNICAL FIELD

The field of the present disclosure is that of insulators for medium-, high-and extra-high-voltage electrical lines.

The present disclosure relates, in particular, to an electrical insulator of the cap/pin type comprising a dielectric element having an outer surface in the form of a skirt that is extended by a metal cap on one side and a metal pin on the other side.

### BACKGROUND

It is well known that insulators for aerial electrical lines can be subjected to very harsh climatic and mechanical conditions.

For example, it is known that these insulators can be subjected to undesirable mechanical stresses representative of an excessive mechanical load exerted by the appearance of a mass when, for example, ice forms on the conductors of the electrical line or on the cap/pin insulators constituting the insulator chains, or as a result of snow accumulation at the conductors of the electrical line.

When such a mass becomes too great, there is a risk that the pylon or any other part of the line (conductor, metal accessory, etc.) may break, causing permanent damage to the line and interrupting the power supply.

In the context of power grid monitoring, it is already known to integrate a detection device, such as a surface leakage current detection device on glass or porcelain string insulators of the cap/pin type, in order to detect and measure surface leakage currents on this type of installation, as described in document EP 2884292 or document EP 3312622.

Document WO 2022/123509 A1 relates to an anchoring system for aerial electrical lines, equipped with a measuring instrument.

Document JP 2000 276957 A relates to an insulator for aerial lines that indicates deterioration.

Document CN 107 424 691 A relates to an insulator that prevents fractures.

Document US 2018/106846 A1 relates to an insulator for aerial electrical lines with a protected leakage current detector.

Document CN 206 163 204 U relates to a suspension insulator and a transmission line.

Document U.S. Pat. No. 5,568,132 A relates to a load insulator, intended to electrically isolate a crane from the load it is lifting, and optionally fitted with load sensors.

Operators of electrical lines would like to be able to take further measurements directly on an insulator, so as to improve the monitoring of electrical lines and be able to intervene even before a power supply interruption occurs due to a fault in the electrical lines. It is also desirable to be able to detect mechanical overloads before any irreversible deformation of the mechanical parts.

When it comes to monitoring aerial electrical line installations in cold, wet regions-although not exclusively-insulator manufacturers and equipment manufacturers in general, as well as operators, are thus looking to develop new monitoring processes.

### BRIEF SUMMARY

The present disclosure relates, in particular, to an electrical insulator of the cap/pin type comprising a dielectric element having an outer surface in the form of a skirt that is extended by a metal cap on one side and a metal pin on the other side.

This can be an insulator with dielectric elements made of tempered glass, porcelain or ceramic, for example, of the cap-and-pin (cap/pin) type, which are assembled in a string.

It can also be a rigid barrel insulator with porcelain or ceramic dielectric elements.

These insulators can be suspended from or anchored to a pylon in order to support a medium-, high-or extra-high-voltage electrical line in the air.

In a known manner, electrical suspension insulators, more particularly so-called cap/pin insulators such as the insulator 1 shown in FIGS. 1A and 1B, can comprise an insulating skirt 2 made of a dielectric material, a metal cap 4 with a top and a base, the metal cap 4 having an upper part 4′ provided with a recess (T) and a lower part 4″ provided with a cavity that is open toward the base of the metal cap 4. The recess (T) has a lateral opening extending until the top of the metal cap (4).

An upper part 3 of the skirt 2 is housed in the cavity of the metal cap 4. The upper part 3 of the skirt 2 is connected to the metal cap 4 by a sealing element 5 (cement or mortar).

A first end of a metal pin 6 is connected by this same sealing element 5 in a cavity 7 of the skirt inside the upper part 3 of the skirt 2.

In a known way, such suspension electrical insulators are intended to be assembled together in series by nesting a second free end of the metal pin 6 of one electrical insulator into the recess (T) of the upper part 4′ of the metal cap 4 of an adjacent electrical insulator to form an insulator string. This insulator string is therefore capable of holding in the air, under horizontal tension (anchoring) or vertical tension (suspension), electrical cables to be suspended from a pylon (P) for medium-, high-and extra-high-voltage aerial electrical lines (E), as shown in FIGS. 2A and 2B.

The present disclosure provides an insulator for aerial electrical lines equipped with a mechanical load detection device to allow remote monitoring of aerial electrical line installations.

To this end, an embodiment of the present disclosure is an insulator of the cap/pin type for aerial electrical lines comprising a dielectric member having an outer surface in the form of a skirt that is extended by a metal cap on a first side of the dielectric member, and a metal pin on a second side of the dielectric member, opposite to the first side, and a mechanical load detection device comprising at least one strain gauge, the strain gauge being fastened to the metal cap of the insulator so as to be used to detect mechanical stresses representative of a mechanical load exerted on the electrical line, the metal cap comprising an upper part provided with a recess for receiving a metal pin or a metal attachment fitting, and the at least one strain gauge being fastened to the outer surface of the upper part of the metal cap.

The insulator according to the present disclosure may have the following specific features:
the at least one strain gauge can be bonded to the outer surface of the upper part of the metal cap;
the load detection device may also comprise a data transmission device capable of recording in computer memory values representative of mechanical loads measured by at least one mechanical sensor including the at least one strain gauge and associated with an electronic conditioner, and of transmitting data to a station remote from the insulator;
the load detection device may comprise a protective element for the at least one strain gauge;
the load detection device may comprise a plurality of strain gauges fastened to the metal cap of the insulator, preferably at the outer surface of the upper part of the metal cap;
the dielectric element can be made of glass, porcelain or ceramic.

Therefore, the idea behind the present disclosure involves placing at least one strain gauge on an insulator at the upper part of the metal cap, which is provided with a recess forming a housing for a metal pin (or a metal attachment fitting). It is at this upper part of the metal cap, into which the metal pin of an adjacent insulator in the insulator is nested, that the maximum mechanical (micro) deformations can occur, the deformations being linked to mechanical stresses representative of a mechanical load exerted on the aerial electrical line.

Results of mechanical deformation measurements by the mechanical load detection device can be sent by any type of communication mode to a station for monitoring electrical lines of a power grid.

In the event of measuring mechanical deformations exceeding a predefined threshold on an aerial electrical line, information comprising a monitoring alert signal can be sent to warn an operator of the possible overloading of the electrical line in question and the risk of failure if no action is taken by the operator.

The mechanical load detection device of the insulator according to the present disclosure can be arranged to manage its behavior in an event-driven way, i.e., by taking into account the evolution of the measurement of mechanical deformations exerted on the electrical line and/or based on the external conditions.

The insulator according to the present disclosure is generally the first insulator (pylon side) of an insulator string, the one closest to the pylon that is used for anchoring the insulator string to the pylon.

### BRIEF DESCRIPTION OF THE DRAWINGS

The present disclosure will be better understood, and further advantages will become apparent from the following description and from the accompanying drawings, in which:

FIG. 1A is a schematic illustration of an insulator according to the present disclosure of the cap/pin type and FIG. 1B shows an axial cross-sectional view of the insulator of FIG. 1A;

FIG. 2A is a schematic illustration of a suspension insulator string with dielectric elements assembled in series, and FIG. 2B is a schematic illustration of an insulator string of the type shown in FIG. 2A installed on a pylon and supporting a medium-, high-or extra-high-voltage aerial electrical line in the air at the pylon;

FIGS. 3A-3E are schematic illustrations of an insulator according to the present disclosure to be fitted with one or more strain gauges on the metal cap of the insulator;

FIG. 4 is a schematic illustration of an insulator according to the present disclosure equipped with a plurality of strain gauges; and

FIGS. 5A and 5B are illustrations of an insulator according to the present disclosure using a clevis-tenon attachment system.

### DETAILED DESCRIPTION

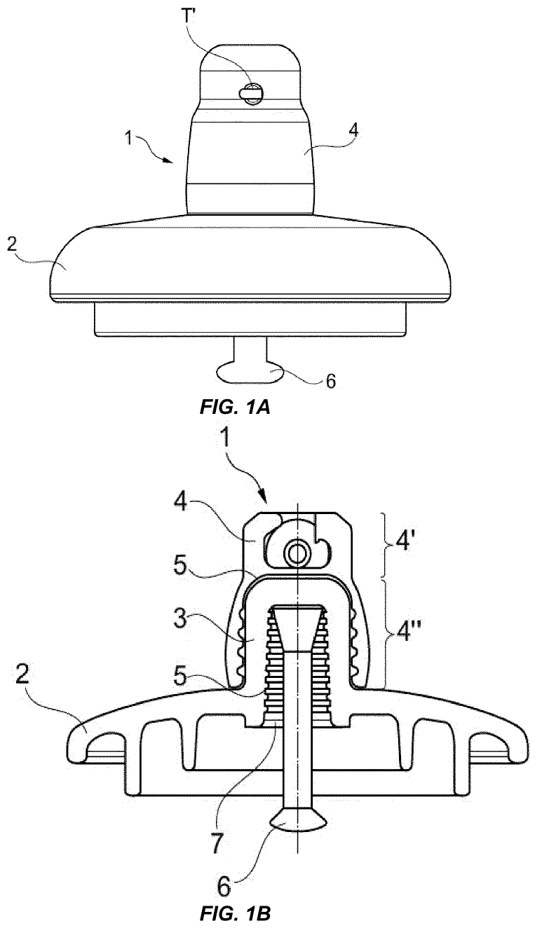

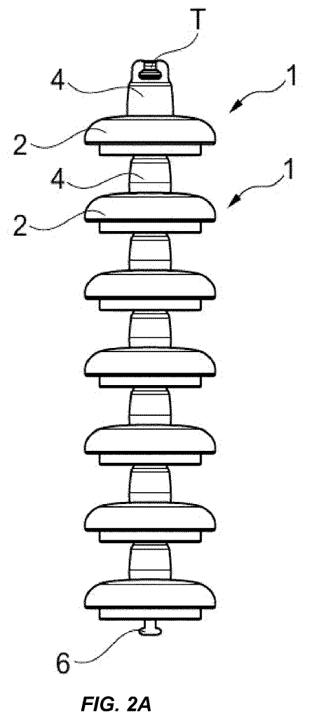

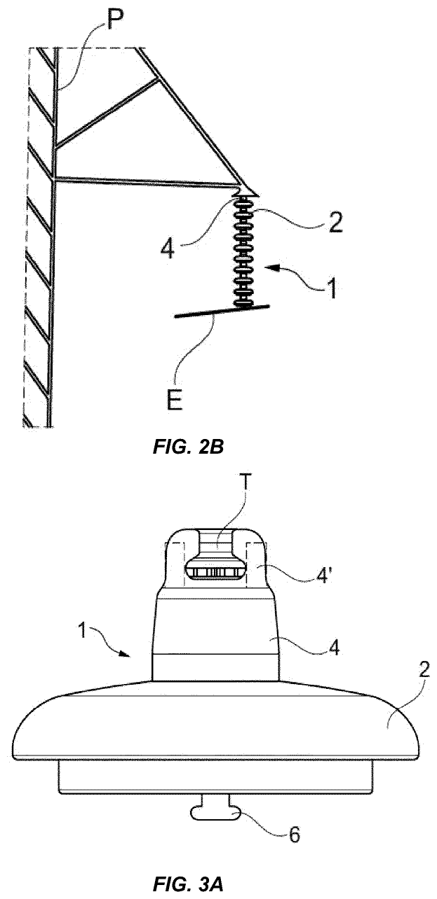

FIGS. 1A, 1B, 2A and 2B have already been discussed.

An insulator 1 of the cap/pin type for aerial electrical lines comprises a glass, porcelain or ceramic dielectric end element, having an outer surface in the form of a skirt 2, which is extended by a metal cap 4 of galvanized cast iron on a first side of the insulator 1 and a metal pin 6 on a second side of the insulator 1 opposite the first side.

As already seen, such suspension electrical insulators are assembled together in series by nesting the free end of the metal pin 6 of one electrical insulator (or a metal attachment fitting) into the recess T of the cylindrical upper part 4′ of the metal cap 4 of an adjacent electrical insulator.

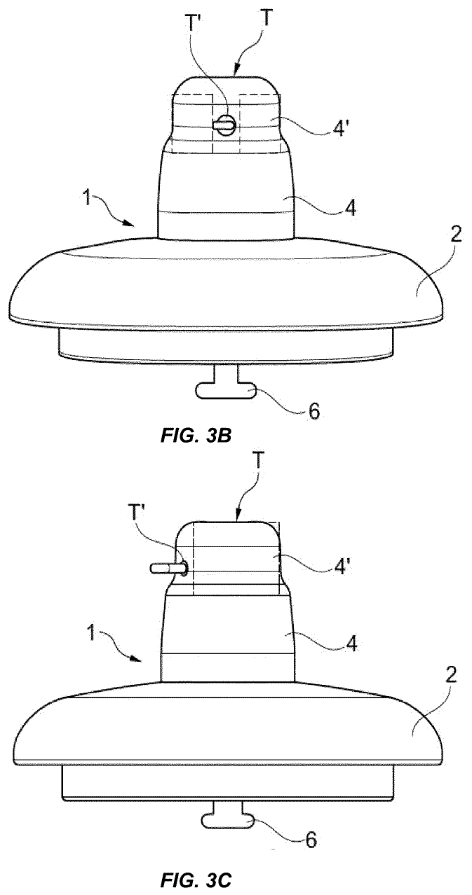

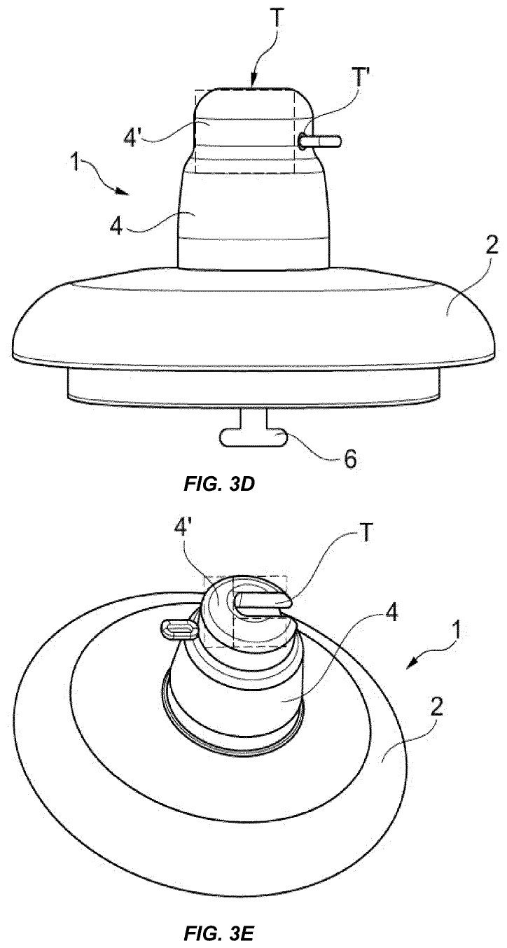

An insulator 1 with its skirt 2, its metal cap 4 and its metal pin 6 is shown in a plurality of views in FIGS. 3A to 3E. As can be seen in FIG. 3A, the recess T is in the form of a lateral opening in the upper part 4′ of the metal cap 4, and herein has a shape complementary to the free end of the metal pin 6 (or a shape complementary to a metal attachment fitting). This recess T has a retention collar on the top of the upper part 4′ of the metal cap 4, to retain the metal pin 6 or the metal attachment fitting under tension.

Generally, in order to hold the metal pin 6 in the recess T or the metal attachment fitting, a pin is inserted into a pin hole T′arranged through the upper part 4′ of the metal cap 4 and leading into the recess T.

A pin hole T′ is arranged on the circumference of the upper part 4′ of the metal cap 4 and leads into the recess T for the passage of a locking pin for locking the metal pin 6 in the upper part 4′. This pin hole T′ can be seen in FIGS. 3A and 3B. Herein, the pin hole T′ is arranged opposite the side opening.

To detect mechanical stresses representative of a mechanical load exerted on the electrical line, the insulator according to the present disclosure comprises a mechanical load detection device. This device comprises one or more strain gauges C (sometimes also called stress gauges) fastened to the metal cap 4 of the insulator 1. Preferably, the one or more strain gauges are fastened to the outer surface of the circumference of the upper part 4′ of the metal cap 4, at the areas shown by dotted frames around the recess in FIGS. 3A to 3D, but can also be fastened to the outer surface of the top of the upper part 4′ of the metal cap 4 at the areas shown by dotted frames as shown in FIG. 3E.

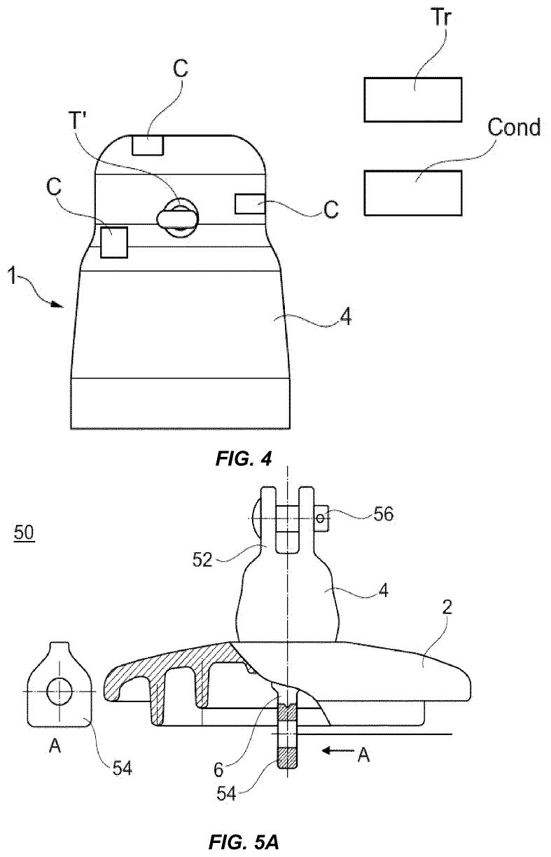

Preferably, the one or more strain gauges are bonded to the upper part 4′ of the metal cap 4, on areas where the galvanized surface of the metal cap 4 has been smoothed either by sanding the galvanized surface or by adding a layer (such as glue or resin) to the galvanized surface. Any other known means for fastening the one or more strain gauges can be considered. FIG. 4 illustrates an example in which three strain gauges are fastened to the upper part 4′ of the metal cap 4, one strain gauge being fastened to the outer surface of its top and two strain gauges being fastened to the outer surface of its circumference.

The load detection device also comprises a data transmission device Tr depicted in FIG. 4. This data transmission device is capable of recording in computer memory values representative of mechanical loads measured by one or more strain transducers (not shown) (each strain transducer including one or more strain gauges associated with an electronic conditioner Cond) and of transmitting the data to a remote station (not shown) of the insulator.

The level of mechanical load can be measured continuously or discretely by the insulator equipped with its one or more sensors, and the measurements can be sent regularly by the remote station by any type of communication mode to a station for monitoring electrical lines of a power grid.

The level of mechanical load can also be measured continuously or discretely by the insulator equipped with its one or more sensors, and only if a predetermined threshold representative of abnormal mechanical deformation at the metal cap 4 representative of mechanical load at the aerial line is exceeded, a monitoring alert signal can be sent by the remote station by any type of communication mode to a station for monitoring electrical lines of a power grid to warn an operator of the electrical line in question. This will allow the operator to take the necessary steps according to the level of alert received.

It is advantageous to protect the one or more strain gauges from the elements in order to limit malfunction. Thus, the load detection device comprises a protective element (not shown) for the one or more strain gauges, and this protective element could be, for example, a sleeve made of a flexible, elastic and electrically insulating material, for example, silicone, the sleeve fitting over the metal cap 4 of the insulator 1. The protective element could just as easily be a coating deposited locally on the one or more strain gauges, such as a resin-or silicone-type coating.

Preferably, the insulator 1 according to the present disclosure is the first insulator of an insulator string, the one closest to the pylon (P) that is used for anchoring the insulator string to the pylon. The metal cap 4 can be extended axially by a metal attachment fitting for attaching the insulator 1 to the pylon P, this metal attachment fitting having a free end similar to the free end of a metal insulator pin 6.

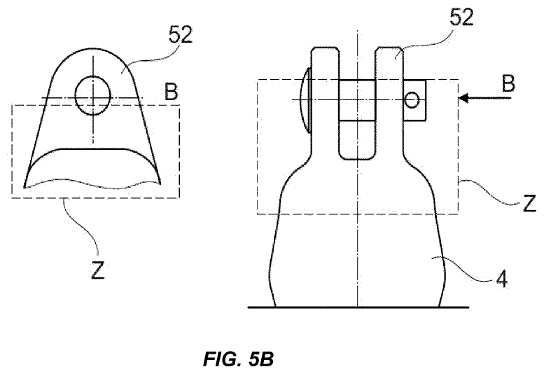

This present disclosure also applies to insulators with attachment fittings other than those detailed in this text. For example, it also applies to insulators in which the metal fittings are connected to each other by a clevis-tenon system as shown in FIG. 5A, with an insulator 50 comprising a clevis 52 terminating a metal cap 4 partially covering a skirt 2 of a dielectric element, a tenon 54 terminating the pin 6, and a fastening shaft 56. In this case, the gauges would be bonded to the base of the tenon and/or to the actual tenon, for example, at the areas indicated by Z in FIG. 5B.

FIGS. 5A and 5B show a perpendicular view A and a perpendicular view B of the tenon 54 and the clevis 52, respectively.

It goes without saying that the present invention is not restricted to the embodiment described above and may be modified without departing from the scope of the invention as defined by the claims.

1. A cap/pin insulator for aerial electrical lines, comprising a dielectric member having an outer surface in the form of a skirt that is extended by a metal cap on a first side of the insulator and a metal pin on a second side of the insulator, opposite to the first side, and a mechanical load detection device comprising at least one strain gauge, wherein the strain gauge is fastened to the metal cap of the insulator so as to be used to detect mechanical stresses representative of a mechanical load exerted on the electrical line, and wherein the metal cap comprises a cylindrical upper part having a recess for receiving a metal pin or a metal attachment fitting, and wherein the at least one strain gauge is fastened to the outer surface of the upper part of the metal cap.

2. The insulator of claim 1, wherein the at least one strain gauge is bonded to the outer surface of the upper part of the metal cap.

3. The insulator of claim 2, wherein the load detection device comprises a data transmission device capable of recording in computer memory values representative of mechanical loads measured by at least one mechanical sensor including the at least one strain gauge associated with an electronic conditioner, and capable of transmitting data to a station remote from the insulator.

4. The insulator of claim 3, wherein the load detection device comprises a protective element for protecting the at least one strain gauge.

5. The insulator of claim 4, wherein the load detection device comprises a plurality of strain gauges fastened to the metal cap of the insulator.

6. The insulator of claim 5, wherein the dielectric member is made of glass, porcelain or ceramic.

7. The insulator of claim 1, wherein the load detection device comprises a data transmission device capable of recording in computer memory values representative of mechanical loads measured by at least one mechanical sensor including the at least one strain gauge associated with an electronic conditioner, and capable of transmitting data to a station remote from the insulator.

8. The insulator of claim 1, wherein the load detection device comprises a protective element for protecting the at least one strain gauge.

9. The insulator of claim 1, wherein the load detection device comprises a plurality of strain gauges fastened to the metal cap of the insulator.

10. The insulator of claim 1, wherein the dielectric member is made of glass, porcelain or ceramic.
